(19) United States
(12) Patent Application Publication
(10) Pub. No.: US 2025/0039036 A1
(43) Pub. Date: Jan. 30, 2025

(54) DETECTION OF ANOMALIES IN A NETWORK

(71) Applicant: Cisco Technology, Inc., SanJose, CA (US)

(72) Inventors: Olivier Cédric Guilhem Calvet, Miribel (FR); Oualid Koucham, Oullins (FR); Yohann Hako Moukam, Lyon (FR)

(21) Appl. No.: 18/227,654

(22) Filed: Jul. 28, 2023

(51) Int. Cl. H04L 41/0631; H04L 41/14; H04L 43/0852

(52) U.S. Cl. CPC H04L 41/0631; H04L 41/145; H04L 43/0852

(57) ABSTRACT

Detection of anomalies in a network are disclosed. In one embodiment, a process observes a communication network with automated systems for packet inter-arrival times between particular devices having stable or periodic communications within the communication network. The process models a distribution of packet inter-arrival times between the particular devices based on observing. The process detects a problematic change in the packet inter-arrival times between the particular devices based on continued observing and mitigates the problematic change in the packet inter-arrival times between the particular devices.

### TECHNICAL FIELD

The present disclosure relates generally to computer networks, and, more particularly, to detection of anomalies in a network, such as an operational technology network.

### BACKGROUND

Programmable Logic Controllers (PLC) play a crucial role in modern operational technology (OT) networks. In conjunction with Input/Output (I/O) modules, they provide a robust and flexible way to automate and control industrial systems by continuously monitoring their state and manipulating actuators to perform a variety of tasks. However, such networks can occasionally experience undesirable changes or reconfigurations that can have a negative impact on the PLCs and/or I/O modules, which can in turn result in inaccurate performance of the tasks performed by these components.

One type of undesirable reconfiguration can manifest if the periodicity of communications to or from the PLCs is altered by, for example, a nefarious entity, an automatic reconfiguration process, and/or an inappropriate action by an operator of the OT network. Other types of undesirable behaviors, such as jitter and/or intermittent or sporadic disconnections in network communications, can manifest erratically, traditionally being a tedious task for network operators to identify in order to diagnose and maintain their network.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example self learning network (SLN) infrastructure;

FIG. 4 illustrates an example operational technology (OT) network;

FIGS. 5A-5B illustrate an example of jitter detection in a network;

FIGS. 6A-6B illustrate an example of periodicity change detection in a network;

FIGS. 7A-7B illustrate an example of intermittent disconnection detection in a network; and

FIG. 8 illustrates an example simplified procedure for detection of anomalies in a network.

### DESCRIPTION OF EXAMPLE EMBODIMENTS

### Overview

According to one or more embodiments of the disclosure, a process observes a communication network with automated systems for packet inter-arrival times between particular devices having stable or periodic communications within the communication network. The process models a distribution of packet inter-arrival times between the particular devices based on observing. The process detects a problematic change in the packet inter-arrival times between the particular devices based on continued observing and mitigates the problematic change in the packet inter-arrival times between the particular devices.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

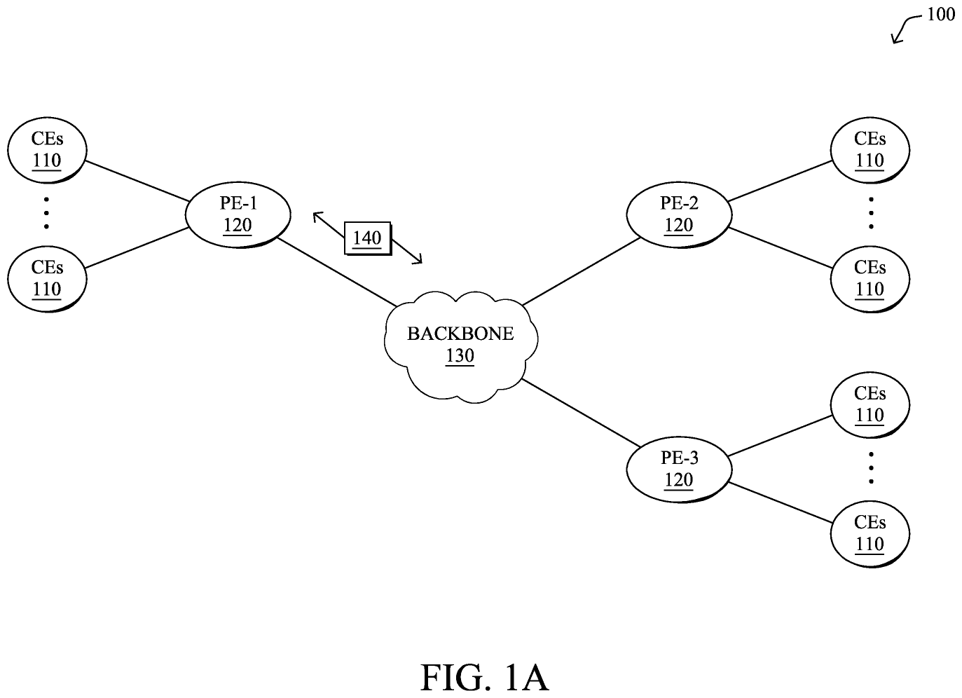

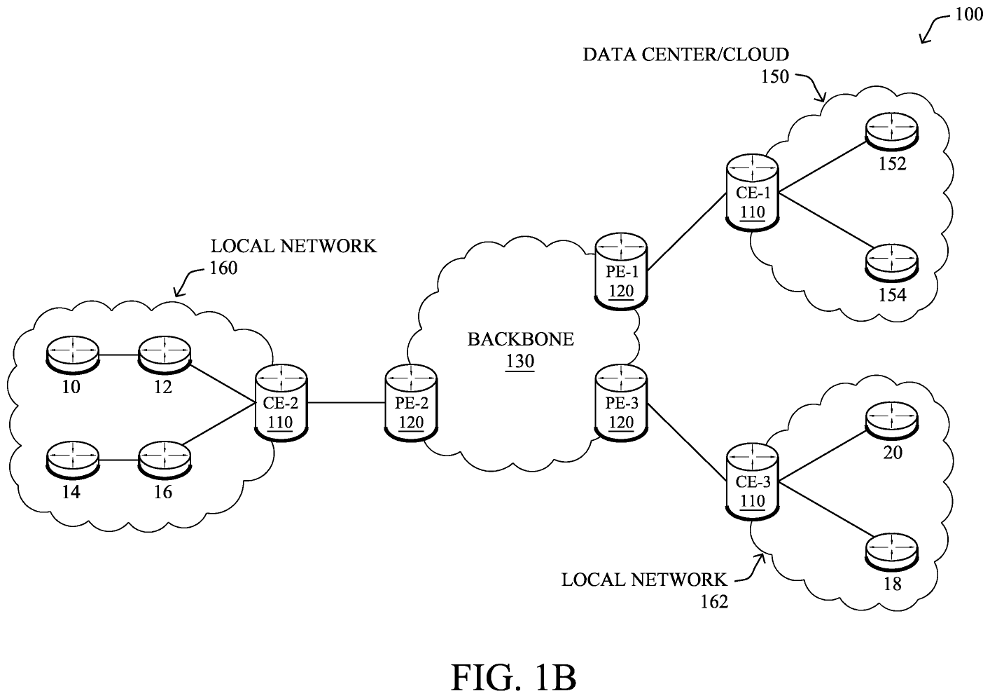

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations, particularly to operational technology (OT) networks, as described below. For example, the techniques herein may be applied to peering points with high-speed links, data centers, etc.

In various embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for devices/nodes 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QOS), security, network management, and traffic engineering extremely challenging, to mention a few.

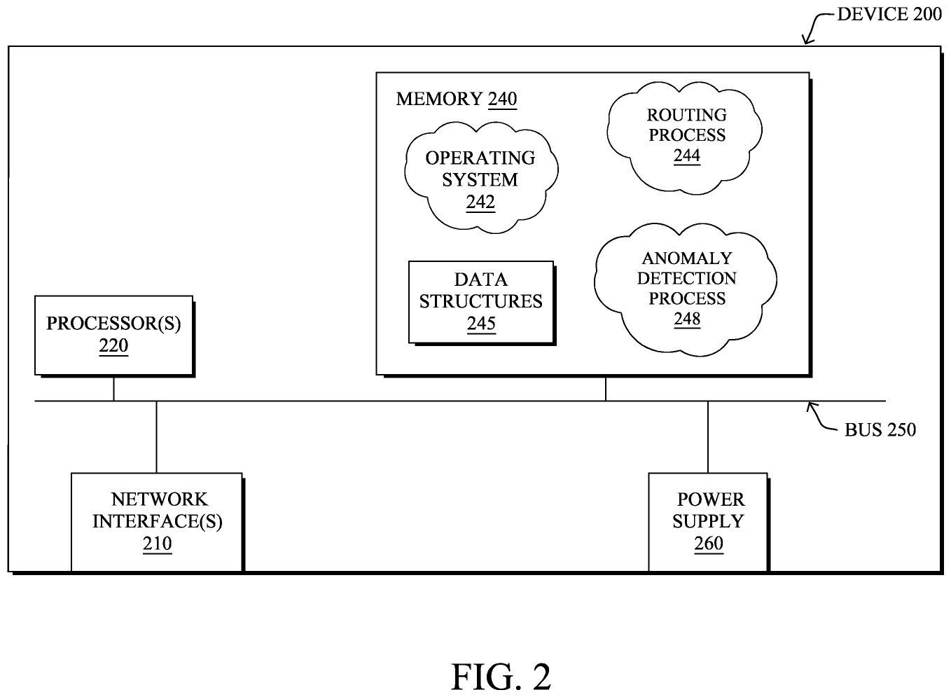

FIG. 2 is a schematic block diagram of an example node/device 200 that may be used with one or more embodiments described herein, e.g., as any of the computing devices shown in FIGS. 1A-1B, particularly the PE routers 120, CE routers 110, nodes/device 10-20, servers 152-154 (e.g., a network controller located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise routing process 244 (e.g., routing services) and illustratively, an anomaly detection process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

Routing process 244 include computer executable instructions executed by processor 220 to perform functions provided by one or more routing protocols, such as the Interior Gateway Protocol (IGP) (e.g., Open Shortest Path First, “OSPF,” and Intermediate-System-to-Intermediate-System, “IS-IS”), the Border Gateway Protocol (BGP), etc., as will be understood by those skilled in the art. These functions may be configured to manage a forwarding information database including, e.g., data used to make forwarding decisions. In particular, changes in the network topology may be communicated among devices 200 using routing protocols, such as the conventional OSPF and IS-IS link-state protocols (e.g., to “converge” to an identical view of the network topology).

Anomaly detection process 248 includes computer executable instructions that, when executed by processor(s) 220, cause device 200 to perform anomaly detection functions as part of an anomaly detection infrastructure within the network. In general, anomaly detection attempts to identify patterns that do not conform to an expected behavior. For example, in one embodiment, the anomaly detection infrastructure of the network may be operable to detect network attacks (e.g., DDoS attacks, the use of malware such as viruses, rootkits, etc.). However, anomaly detection in the context of computer networking typically presents a number of challenges: 1.) a lack of a ground truth (e.g., examples of normal vs. abnormal network behavior), 2.) being able to define a “normal” region in a highly dimensional space can be challenging. 3.) the dynamic nature of the problem due to changing network behaviors/anomalies, 4.) malicious behaviors such as malware, viruses, rootkits, etc. may adapt in order to appear “normal,” and 5.) differentiating between noise and relevant anomalies is not necessarily possible from a statistical standpoint, but typically also requires domain knowledge.

Anomalies may also take a number of forms in a computer network: 1.) point anomalies (e.g., a specific data point is abnormal compared to other data points), 2.) contextual anomalies (e.g., a data point is abnormal in a specific context but not when taken individually), or 3.) collective anomalies (e.g., a collection of data points is abnormal with regards to an entire set of data points). Generally, anomaly detection refers to the ability to detect an anomaly that could be triggered by the presence of malware attempting to access data (e.g., data exfiltration), spyware, ransom-ware, etc. and/or non-malicious anomalies such as misconfigurations or misbehaving code. Particularly, an anomaly may be raised in a number of circumstances:
Security threats: the presence of a malware using unknown attacks patterns (e.g., no static signatures) may lead to modifying the behavior of a host in terms of traffic patterns, graphs structure, etc. Machine learning processes may detect these types of anomalies using advanced approaches capable of modeling subtle changes or correlation between changes (e.g., unexpected behavior) in a highly dimensional space. Such anomalies are raised in order to detect, e.g., the presence of a 0-day malware, malware used to perform data ex-filtration thanks to a Command and Control (C2) channel, or even to trigger (Distributed) Denial of Service (DOS) such as DNS reflection, UDP flood, HTTP recursive get, etc. In the case of a (D) DoS, although technical an anomaly, the term “DoS” is usually used.

Anomaly detection process 248 may detect malware based on the corresponding impact on traffic, host models, graph-based analysis, etc., when the malware attempts to connect to a C2 channel, attempts to move laterally, or exfiltrate information using various techniques.
Misbehaving devices: a device such as a laptop, a server of a network device (e.g., storage, router, switch, printer, etc.) may misbehave in a network for a number of reasons: 1.) a user using a discovery tool that performs (massive) undesirable scanning in the network (in contrast with a lawful scanning by a network management tool performing device discovery), 2.) a software defect (e.g. a switch or router dropping packet because of a corrupted RIB/FIB or the presence of a persistent loop by a routing protocol hitting a corner case).
Dramatic behavior change: the introduction of a new networking or end-device configuration, or even the introduction of a new application may lead to dramatic behavioral changes. Although technically not anomalous, an SLN-enabled node having computed behavioral model(s) may raise an anomaly when detecting a brutal behavior change. Note that in such as case, although an anomaly may be raised, a learning system such as SLN is expected to learn the new behavior and dynamically adapts according to potential user feedback.
Misconfigured devices: a configuration change may trigger an anomaly: a misconfigured access control list (ACL), route redistribution policy, routing policy, QoS policy maps, or the like, may have dramatic consequences such a traffic black-hole, QoS degradation, etc. Anomaly detection process 248 may advantageously identify these forms of misconfigurations, in order to be detected and fixed.

In various embodiments, anomaly detection process 248 may utilize machine learning techniques, to perform anomaly detection in the network. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

Computational entities that rely on one or more machine learning techniques to perform a task for which they have not been explicitly programmed to perform are typically referred to as learning machines. In particular, learning machines are capable of adjusting their behavior to their environment. For example, a learning machine may dynamically make future predictions based on current or prior network measurements, may make control decisions based on the effects of prior control commands, etc.

For purposes of anomaly detection in a network, a learning machine may construct a model of normal network behavior, to detect data points that deviate from this model. For example, a given model (e.g., a supervised, un-supervised, or semi-supervised model) may be used to generate and report anomaly scores to another device. Example machine learning techniques that may be used to construct and analyze such a model may include, but are not limited to, nearest neighbor (NN) techniques (e.g., k-NN models, replicator NN models, etc.), statistical techniques (e.g., Bayesian networks, etc.), clustering techniques (e.g., k-means, etc.), neural networks (e.g., reservoir networks, artificial neural networks, etc.), support vector machines (SVMs), or the like.

One class of machine learning techniques that is of particular use in the context of anomaly detection is clustering. Generally speaking, clustering is a family of techniques that seek to group data according to some typically predefined notion of similarity. For instance, clustering is a very popular technique used in recommender systems for grouping objects that are similar in terms of people's taste (e.g., because you watched X, you may be interested in Y, etc.). Typical clustering algorithms are k-means, density based spatial clustering of applications with noise (DBSCAN) and mean-shift, where a distance to a cluster is computed with the hope of reflecting a degree of anomaly (e.g., using a Euclidian distance and a cluster based local outlier factor that takes into account the cluster density).

Replicator techniques may also be used for purposes of anomaly detection. Such techniques generally attempt to replicate an input in an unsupervised manner by projecting the data into a smaller space (e.g., compressing the space, thus performing some dimensionality reduction) and then reconstructing the original input, with the objective of keeping the “normal” pattern in the low dimensional space. Example techniques that fall into this category include principal component analysis (PCA) (e.g., for linear models), multi-layer perceptron (MLP) ANNs (e.g., for non-linear models), and replicating reservoir networks (e.g., for non-linear models, typically for time series).

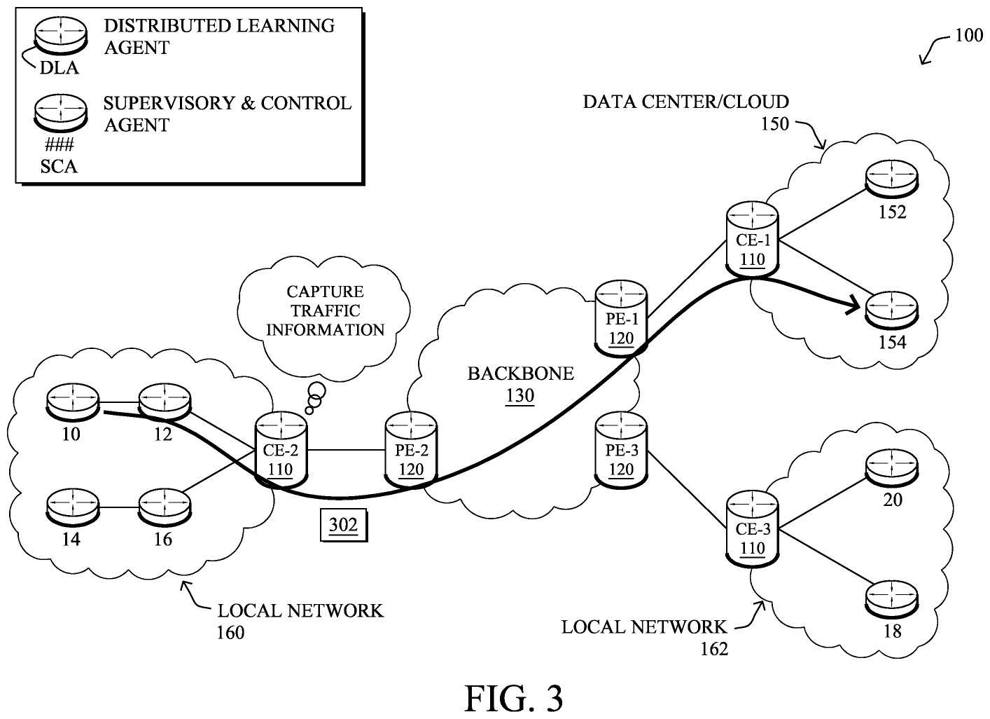

An example self learning network (SLN) infrastructure that may be used to detect network anomalies is shown in FIG. 3, according to various embodiments. Generally, network devices may be configured to operate as part of an SLN infrastructure to detect, analyze, and/or mitigate network anomalies such as network attacks (e.g., by executing anomaly detection process 248). Such an infrastructure may include certain network devices acting as distributed learning agents (DLAs) and one or more supervisory/centralized devices acting as a supervisory and control agent (SCA). A DLA may be operable to monitor network conditions (e.g., router states, traffic flows, etc.), perform anomaly detection on the monitored data using one or more machine learning models, report detected anomalies to the SCA, and/or perform local mitigation actions. Similarly, an SCA may be operable to coordinate the deployment and configuration of the DLAs (e.g., by downloading software upgrades to a DLA, etc.), receive information from the DLAs (e.g., detected anomalies/attacks, compressed data for visualization, etc.), provide information regarding a detected anomaly to a user interface (e.g., by providing a webpage to a display, etc.), and/or analyze data regarding a detected anomaly using more CPU intensive machine learning processes.

### —Detection of Anomalies in Operational Technology Networks—

As noted above, operational technology (OT) networks can be susceptible to undesirable reconfigurations, which can manifest if the periodicity of communications to or from the PLCs is altered by, for example, a nefarious entity, an automatic reconfiguration process, and/or an inappropriate action by an operator of the OT network. Further, OT networks can be susceptible to undesirable reconfigurations, which can manifest as jitter, intermittent disconnections in network communications, and/or sporadic disconnections in the network communications. Moreover, visibility to packet inter-arrival time (PIAT), which could be useful in determining whether the OT has experienced an undesirable reconfiguration, may be obfuscated due to various security features often employed in an OT network.

The techniques herein introduce a new mechanism to perform anomaly detection within an operational technology network, such as an industrial network. As discussed in more detail herein, the mechanism(s) of the disclosure leverage the fact that most traffic in such networks is periodic and predictable in order to detect and mitigate anomalies in the network.

For example, command and control communications between programmable logic controllers (PLCs) and Input/Output (I/O) modules are generally periodic, at a period that is adapted to the controlled process. This periodicity is critical, and a change could cause disruptions to the physical process controlled by the PLC. If the period is too high, the state of the physical process as seen by the supervision might not be up to date with the real state, which could impact the feedback loop and therefore corrupt the process. On the contrary, too much communication could introduce latency in the network and the saturation of the PLC or the I/O module, which might not be able to perform their operations in time. For instance, consider the case in which the PLC controls a stamping machine that stamps products being conveyed down a conveyor belt. Any variation in the timing could cause the machine to mis-stamp a product at the wrong location or, in an extreme case, miss the product, entirely.

More specifically, PLCs and other industrial devices that are in charge of automating an industrial process often exhibit periodic communication patterns because of the repetitive nature of production processes. For instance, the devices that control the physical process operate in a cycle that consists in: (i) polling sensor states, (ii) executing some kind of control logic, and (iii) sending commands to actuators. The duration of this cycle is carefully selected to ensure that the devices have an accurate and fresh state of the physical process.

Therefore, in such communications, observing a change in the periodicity of the communications may reveal undesirable reconfiguration which can affect the production process. Such a change can be the consequence of malign external action by an attacker, device automatic reconfiguration triggered by another device, or an inappropriate operator's action. In any case, informing the operators about changes in the periodicity of critical network communications can enable them to take action if need be.

Moreover, PLCs often pilot sensors and actuators through I/O (Input/Output) modules and rely on internal cycles to process and exchange data. Hence, the response time of an I/O or the capability for a PLC to scan all the necessary I/Os in a given period, is critical in the design of the system and its network. For instance, if an I/O takes too much time to reply to requests, this can be considered a serious fault by the system, sometimes triggering an emergency stop and therefore impacting production.

In any case, abnormal response times in such communications (jitter) are signs of suboptimal network behavior that can lead to incidents at the level of the production chains, while abnormally long response times in such communications (disconnections) are signs of faulty equipment such as loose connectors or wires for instance. Given the strict time requirements characteristic of control loops, disconnections can lead to incidents within the physical process.

Jitter and disconnections can lead to lower productivity, revenue loss, physical degradation, bodily harm, and/or environmental pollution, among other negative outcomes. Unfortunately, in general, identifying jitter, intermittent, or sporadic disconnections in network communications is a tedious task for network operators. For example, jitter and disconnections can manifest erratically, and the operators need to wade through hundreds or thousands of communications to focus on the pertinent ones. As such, embodiments of the present disclosure provide an approach to automatically identify jitter and intermittent disconnections to assist operators in the diagnosis and maintenance of their network. Stated alternatively, automatically detecting jitter and intermittent disconnections in industrial networks in accordance with the disclosure can allow for identification of weaknesses in the network that could, if fixed, lead to better/more stable production and improve the overall safety of the industrial installation.

According to one or more embodiments of the disclosure as described in detail below, therefore, a process observes a communication network with automated systems for packet inter-arrival times between particular devices having stable or periodic communications within the communication network, and models a distribution of packet inter-arrival times between the particular devices based on observing. The process may then detect a problematic change in the packet inter-arrival times between the particular devices based on continued observing, and mitigates the problematic change in the packet inter-arrival times between the particular devices, accordingly.

Illustratively, the techniques described herein may be performed by hardware, software, and/or firmware, such as in accordance with the anomaly detection process 248, which may include computer executable instructions executed by the processor 220 (or independent processor of interfaces 210) to perform functions relating to the techniques described herein, e.g., in conjunction with routing process 244.

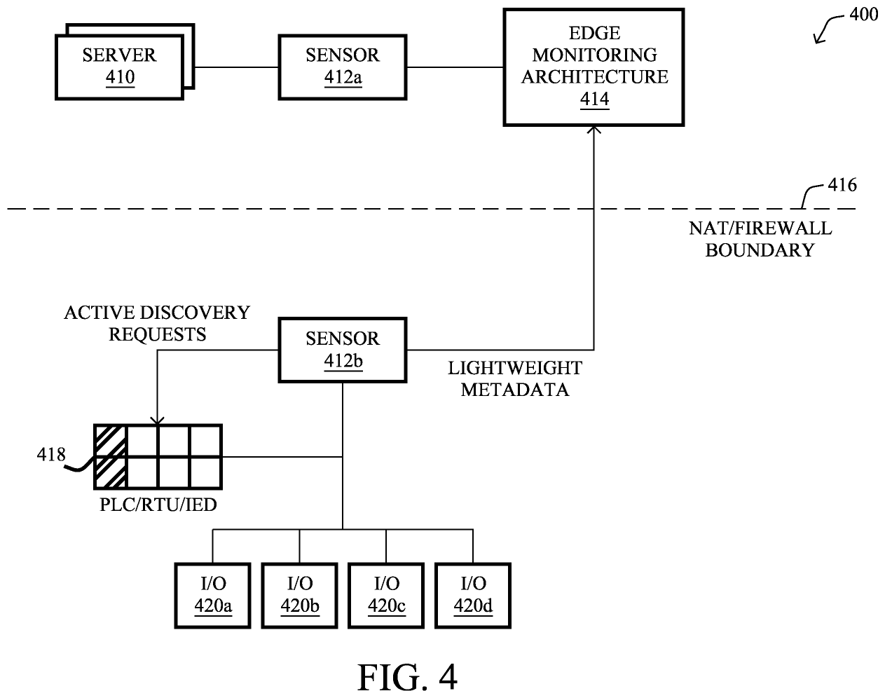

Operationally, FIG. 4 illustrates an example operational technology (OT) network 400. The OT network 400 (which may be referred to herein in the alternative as an “industrial network”), includes one or more servers 410 that are coupled to a first sensor 412a. The servers 410 can be a Supervisory Control and Data Acquisition (SCADA) server, a historian server, or other server and/or client. The first sensor 412a is further coupled to an edge monitoring architecture 414. In some embodiments, the edge monitoring architecture comprises a Cisco Cyber Vision® architecture, or similar architecture that is configured to provide visibility to an industrial control system, such as the OT network 400 of FIG. 4.

As shown in FIG. 4, the server 410, the first sensor 412a, and the edge monitoring architecture are deployed on a first side a network address translation/firewall boundary (NAT/FIREWALL BOUNDARY 416). On a second side of the NAT/FIREWALL BOUNDARY 416, a second sensor 412b is coupled to a device 418. The device(s) 418 can be a programmable logic controller (PLC), a remote terminal unit (RTU), and/or an intelligent end device (IED), or any combination thereof. Further, the second sensor 412b is coupled to a plurality of industrial input/output devices (I/Os) 420a, 420b, 420c, and 420d (referred to collectively as the “I/Os 420” herein). As shown in FIG. 4, the second sensor 412b receives communications from the first sensor 412a and provides lightweight metadata to the edge monitoring architecture 414. In addition, the second sensor 412b supplies active discovery requests to the device(s) 418.

It is noted that most forms of traffic (e.g., packets, communications, commands, etc.) in low-level devices (e.g., the I/Os 420) of the OT network 400 are periodic in nature and generally very consistent. Accordingly, aspects of the present disclosure leverage this fact to capture a packet inter-arrival time (PIAT) of stable communications in the OT network 400. It will be appreciated that, in previous approaches, this may also not be possible due to proprietary protocols (e.g., communications protocols that are owned by a single organization and/or entity and generally do not have a public specification) employed by OT networks 400. However, in accordance with the disclosure, special “embedded” sensors (e.g., the first sensor 412a and/or the second sensor 412b) in connection with the edge monitoring architecture 414 are utilized to capture the PIAT of stable communications in the OT network 400. This allows for pertinent communications that are at the heart of the process control loops within the OT network 400 to be captured and analyzed.

According, in various embodiments, the embedded sensors (e.g., the first sensor 412a and/or the second sensor 412b) may assess the packets being conveyed within the OT network 400 (e.g., between a device 418 and one or more I/Os 420, etc.), to determine the packet inter-arrival time (PIAT) characteristics for each communication of interest. As discussed herein, a “communication of interest” generally refers to a stable low-level device communication.

For each of these communications (e.g., the “communications of interest”), a ‘normal’ distribution of PIAT data from traffic (that is considered ‘normal’) can be determined to use as a reference. This distribution of PIATs is modeled as a mixture of Gaussians by fitting a Gaussian Mixture Model (GMM), although other suitable types of models could also be used as well to model the distribution.

In some embodiments, one or more anomaly models are then constructed as follows for (1) changes in periodicity of the traffic, (2) jitter in the traffic, and/or (3) intermittent disconnections of components of the OT network 400.

First, for changes in the periodicity in the traffic, a footprint of the periodicities in the monitored communication of interest is deduced from the significant Gaussians (those with the highest weights) of the reference PIAT distribution. For each significant Gaussian, a period bin is created, centered on the mean of the Gaussian, and with a width proportional to the Gaussian's standard deviation. The weight of the Gaussian in the mixture is then associated with the corresponding period bin. Finally, the list of couples (weight, period bin), made from all significant Gaussians, constitutes the periodicity footprint.

Next, a detection threshold is set to detect abnormal variations in the periodicity footprint, based on the sum of the weight variation of each bin of the footprint. This periodicity footprint and the detection threshold constitutes the anomaly detection model obtained from this “training” stage.

Finally, inference techniques are employed for detection of an abnormal change in the periodicity of the traffic. For example, for live incoming traffic on the monitored communication of interest, the distribution of the PIATs is periodically captured and, for each bin of the footprint, the difference between the weight of the footprint and the fraction of PIATs of the captured distribution in this bin is determined. If the sum of these differences exceeds the previously defined threshold, it is determined that an abnormal periodicity change has been detected.

To detect (significant) jitter in the traffic, i.e., abnormal response times in industrial communications (jitter), which may also be indicative of suboptimal network behavior, the following processes are employed:

First, from the reference PIATs distribution, modeled as a mixture of Gaussians, Gaussians with a weight exceeding a parametrized threshold are considered significant and will be used to detect Jitter. Second, a threshold is set to consider if a PIAT belongs to any of the significant Gaussians or not. Third, to avoid sporadic isolated detections, a post-processing of the results is performed and the parameters of this post-processing are set at this stage. Next, an output corresponding to the first, second, and third operations is then used for anomaly detection model training,

Finally, inference techniques are employed for the detection of jitter in the traffic, i.e., leveraging the model learned above. For example, for live incoming traffic on the monitored communication, PIATs during a given period are collected and then processed in a batch. In this batch, each packet is assessed to determine if its PIAT belongs to any of the significant Gaussians learned using the threshold from the second operation. If not, it is considered a ‘raw’ detection. Such raw detections are then post-processed to filter out isolated events. In some embodiments, “close-enough” events are aggregated into a detection window of a certain duration and finally detection windows that are not long enough are filtered out such that only the most significant events are reported. Jitter events are then reported as time windows during which an event occurred.

To detect intermittent disconnections, which, similar to the above, exhibit abnormally long response times in such communications (disconnections) and can be signs of faulty equipment such as loose connectors or wires for instance, the following processes are employed:

First, from the reference PIATs distribution, modeled as a mixture of Gaussians, a threshold value is deduced by taking a margin from the higher (common) PIAT value. In contrast to the embodiments above, in these embodiments, defining the detection threshold constitutes the detection model training. Next, the detection of intermittent disconnection in live incoming traffic on the monitored communication is performed by determining, for each packet, if its PIAT exceeds the detection threshold (i.e., an inference made using the trained model above). If the PIAT exceeds the detection threshold for a particular packet, then an intermittent disconnection is detected.

If an anomaly is found from any of the three detection methodologies described above, various mitigation actions could be initiated. Non-limiting examples of such mitigation actions can include sending an alert to a user interface for review by a network administrator/operator, and/or sending out recommendations, such as recommending software and/or hardware changes to the network, among other mitigation actions.

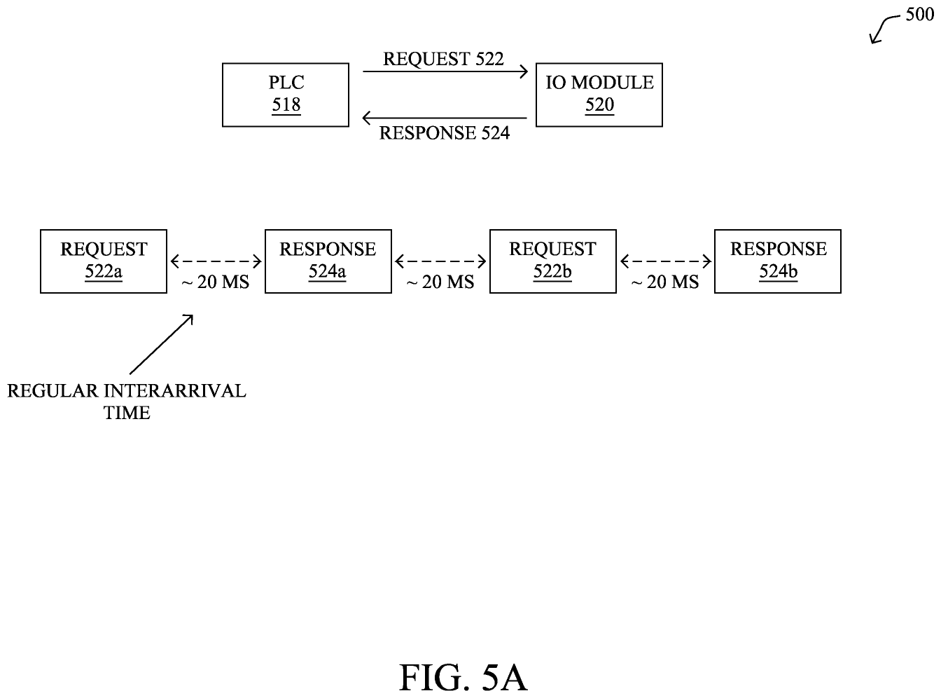

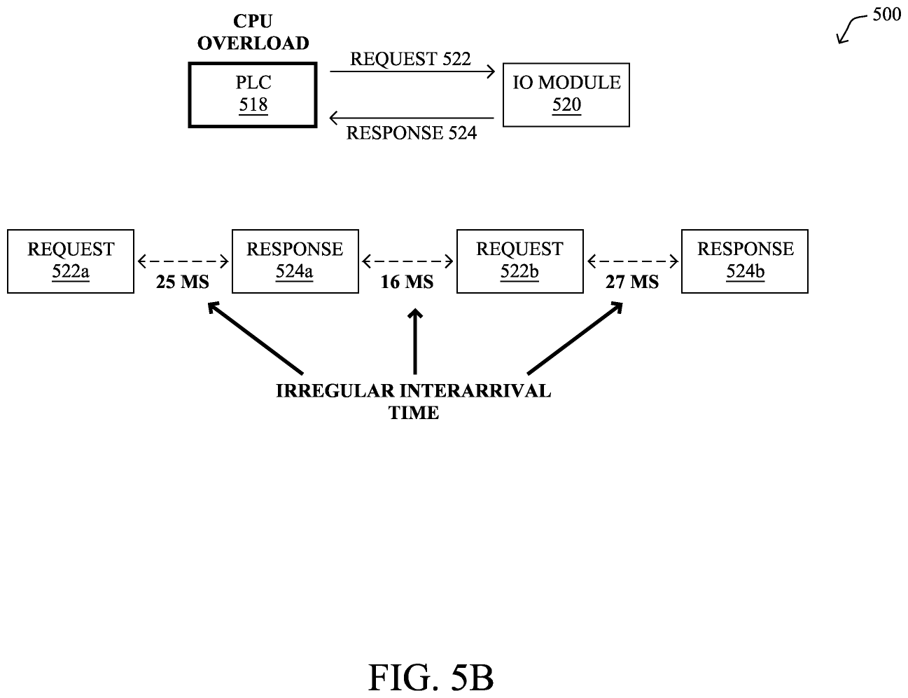

FIG. 5A illustrates an example of a regular inter-arrival time in a network 500. As shown in FIG. 5A, a PLC 518 and an I/O module 520 exchange requests 522 and responses 524. In some embodiments, the PLC 518 can be analogous to the device 418 of FIG. 4 and the I/O module 520 can be analogous to one of the I/Os 420 of FIG. 4.

As shown in FIG. 5A, there is a regular time interval between each request 522 and response 524. This is indicative of periodic communication between the PLC 518 and the I/O module 520 when the network 500 (which can be analogous to the OT network 400 of FIG. 4) is functioning as intended. That is, there is a 20 millisecond (ms) time interval between a first request 522a and a first response 524a. Similarly, there is a 20 ms time interval between the first response 524a and a second request 522b and a 20 ms time interval between the second request 522b and a second response 524b.

FIG. 5B illustrates an example of jitter detection when an irregular inter-arrival time is detected within the network 500. In contrast to the example shown in FIG. 5A, in FIG. 5B, an irregular time interval between the requests 522 and responses 524 is detected. That is, there is a 25 ms time interval between a first request 522a and a first response 524a. Further, there is a 16 ms time interval between the first response 524a and a second request 522b and a 27 ms time interval between the second request 522b and a second response 524b.

In some embodiments, these conditions can be indicative of a particular device (e.g., a central processing unit associated with the PLC 518) being overloaded, which can lead to abnormal behavior within the network 500. This condition coupled with the detection of jitter associated with a threshold percentage of packets in the network 500 can be indicative of too many services being executed within the network 500 and/or too many I/O modules 520 being coupled to the PLC 518, among other possibilities.

Embodiments are not so limited, however, and in some embodiments, these conditions can be indicative of a particular device (e.g., a network switch or switch interface) being overloaded, which can lead to abnormal behavior within the network 500. This condition coupled with the detection of jitter associated with a threshold percentage of packets in the network 500 can be indicative of network congestion at the switch level, among other possibilities.

In order to remedy the irregular inter-arrival time shown in FIG. 5B, the operations discussed above in FIG. 4 in connection with jitter mitigation may be implemented to remedy the issue(s).

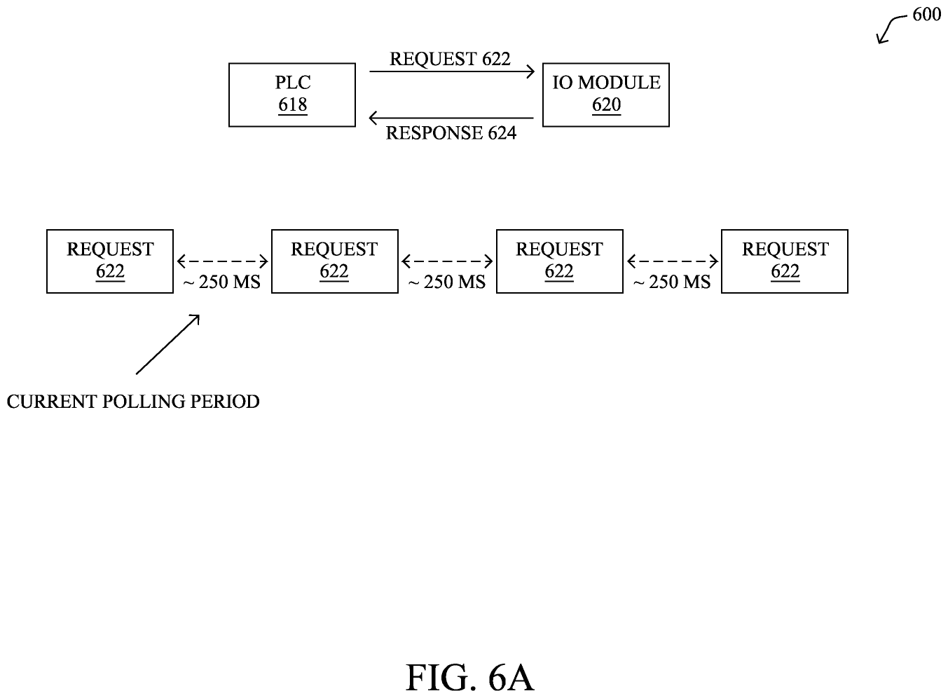

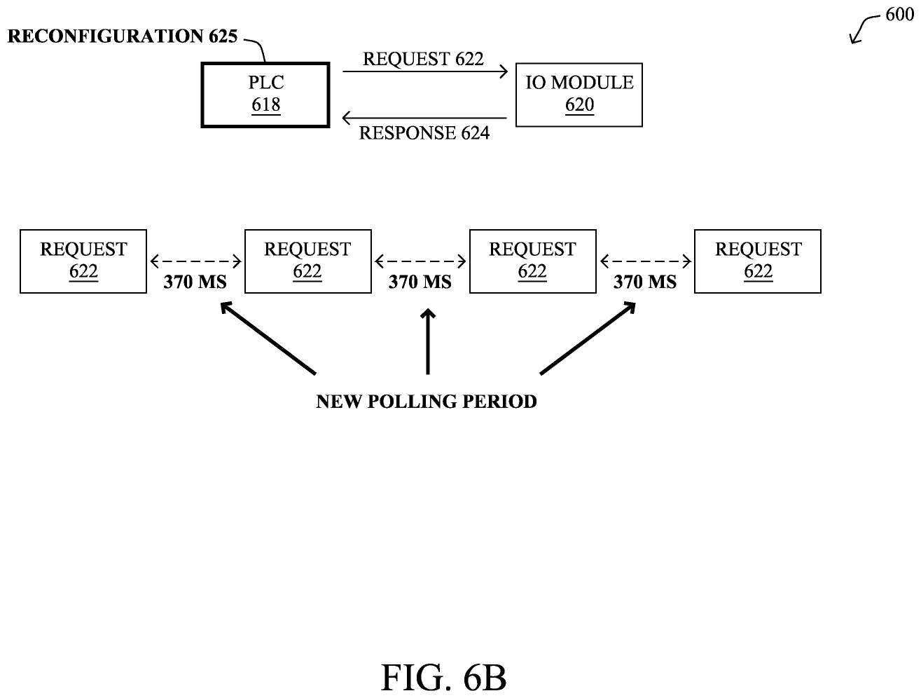

FIG. 6A illustrates an example of a regular periodicity for communications in a network 600. As shown in FIG. 6A, a PLC 618 and an I/O module 620 exchange requests 622 and responses 624. In some embodiments, the PLC 618 can be analogous to the device 418 of FIG. 4 and/or the PLC 518 of FIGS. 5A-5B, and the I/O module 620 can be analogous to one of the I/Os 420 of FIG. 4 and/or the I/O module 520 of FIGS. 5A-5B.

As shown in FIG. 6A, there is a regular polling period between each request 622. This is indicative of periodic communication between the PLC 618 and the I/O module 620 when the network 600 (which can be analogous to the OT network 400 of FIG. 4) is functioning as intended. That is, there is a 250 ms polling period between each request.

FIG. 6B illustrates an example of periodicity change detection when a new polling period is detected. In contrast to the example shown in FIG. 6A, in FIG. 6B, a new periodicity between the PLC 618 and the I/O module 620 has been detected. That is, there is now a 370 ms polling period between the requests.

In response to detecting the new polling period (e.g., a new periodicity in communication between the PLC 618 and the I/O module 620), it may be determined that the PLC 618 may have been reprogrammed and/or a new polling configuration occurred (i.e., “reconfiguration 625), and as such an alert may be generated and/or a new configuration may be provided to a server (e.g., the server 410 of FIG. 4) to remedy the issue(s).

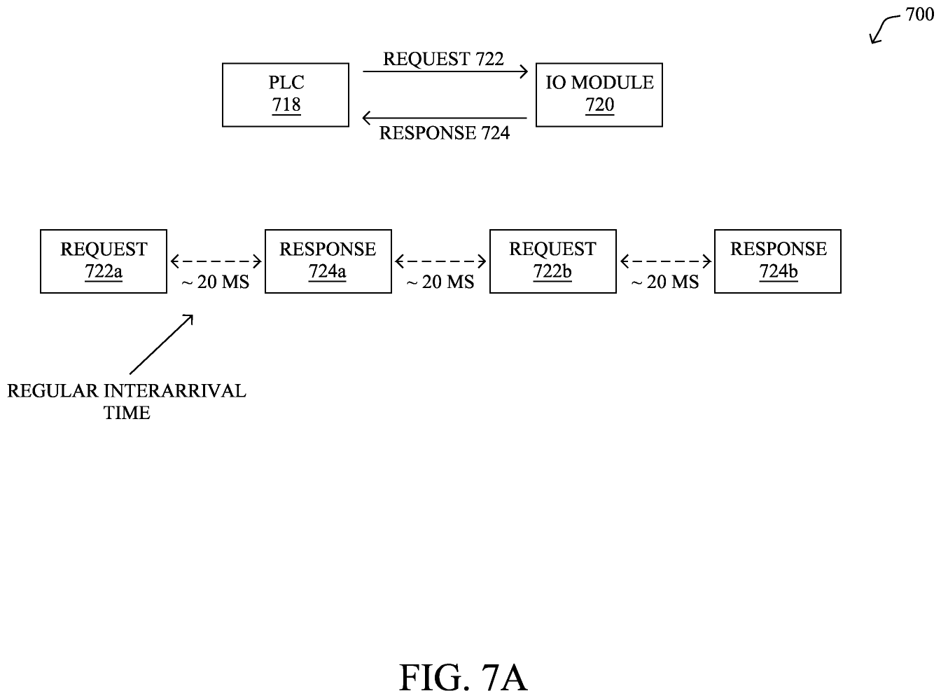

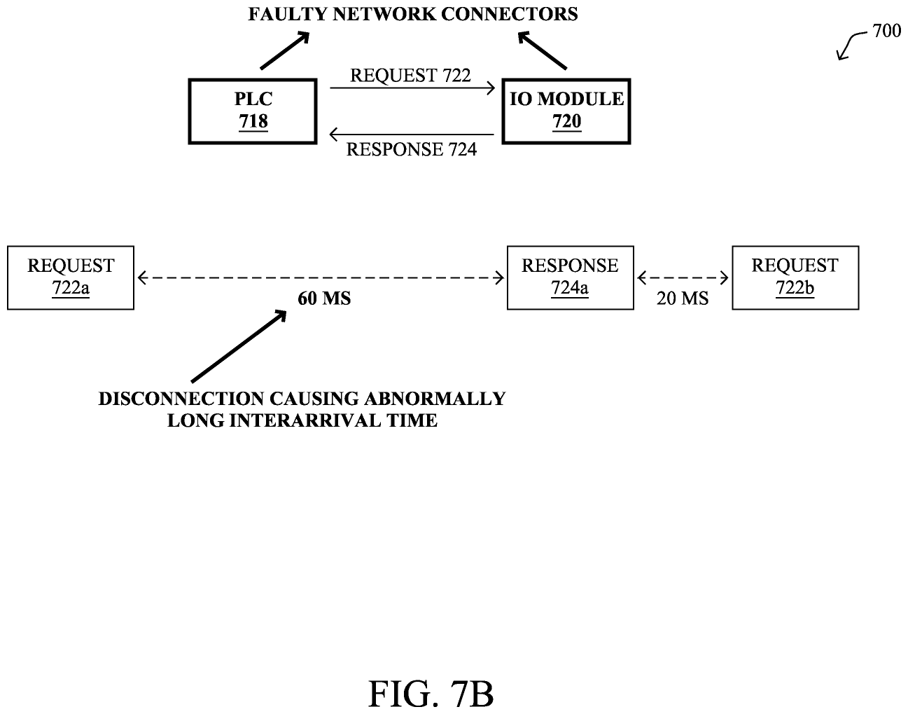

FIG. 7A illustrates an example of a regular inter-arrival time in a network 700. As shown in FIG. 7A, a PLC 718 and an I/O module 720 exchange requests 722 and responses 724. In some embodiments, the PLC 718 can be analogous to the device 418 of FIG. 4, the PLC 518 of FIGS. 5A-5B, and/or the PLC 618 of FIGS. 6A-6B and the I/O module 720 can be analogous to one of the I/Os 420 of FIG. 4, the I/O module 520 of FIGS. 5A-5B, and/or the I/O module 620 of FIGS. 6A-6B.

As shown in FIG. 7A, there is a regular inter-arrival time between each request 722 and response 724. This is indicative of periodic communication between the PLC 718 and the I/O module 720 when the network 700 (which can be analogous to the OT network 700 of FIG. 4) is functioning as intended. That is, there is a 20 ms inter-arrival time between a first request 722a and a first response 724a. Similarly, there is a 20 ms inter-arrival time between the first response 724a and a second request 722b and a 20 ms inter-arrival time between the second request 722b and a second response 724b.

FIG. 7B illustrates an example of intermittent disconnection detection when an irregular inter-arrival time is detected. In contrast to the example shown in FIG. 7A, in FIG. 6B, a disconnection event causing an abnormally long inter-arrival time is detected. That is, there is a 60 ms inter-arrival time between a first request 722a and a first response 724a. However, there is still a 20 ms inter-arrival time between the first response 724a and a second request 722b.

In some embodiments, these conditions can lead to a determination that an intermittent disconnection between the PLC 718 and the I/O module 720 has occurred. This can be indicative of a physical anomaly and/or a faulty contact involving a network interface. In such a case, it may be beneficial to check network interface physical connections to determine if the cause of the intermittent disconnection is a product of faulty wiring. This, in connection with the operations discussed above in FIG. 4 in connection with intermittent disconnection mitigation may be implemented to remedy the issue(s).

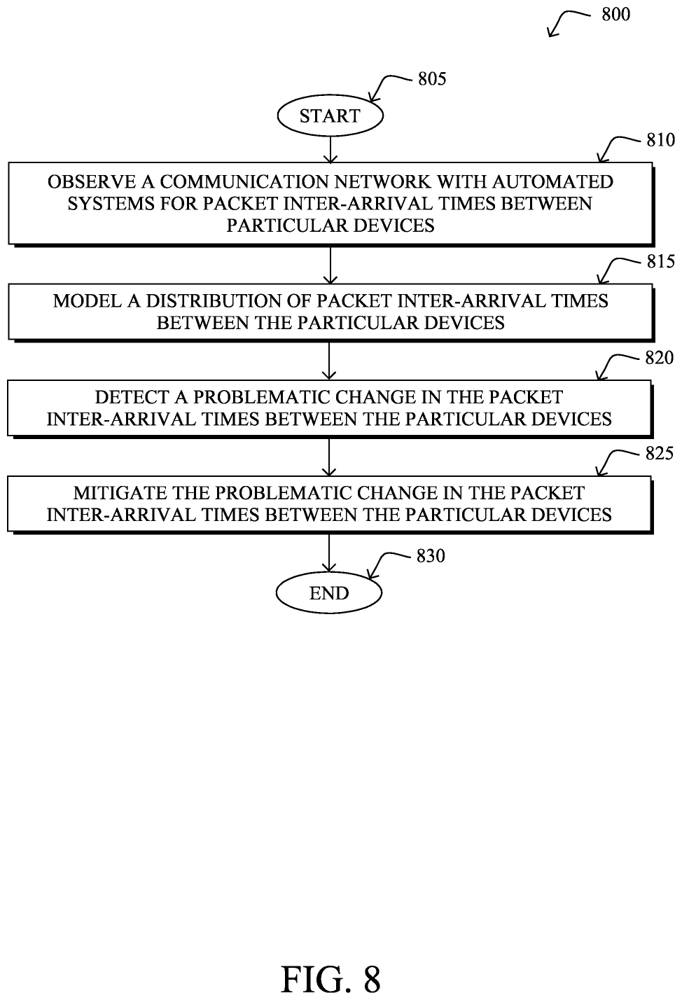

FIG. 8 illustrates an example simplified procedure for detection of anomalies in a network in accordance with one or more embodiments described herein. For example, a non-generic, specifically configured device (e.g., device 200 or other apparatus) may perform procedure 800 (e.g., a method) by executing stored instructions (e.g., process 248). The procedure 800 may start at step 805, and continues to step 810, where, as described in greater detail above, the process observes a communication network with automated systems for packet inter-arrival times between particular devices having stable or periodic communications within the communication network. In various embodiments, the communication network comprises an industrial network.

In some embodiments, the particular devices of the communication network comprise low-level autonomous devices. For example, in some embodiments, the particular devices of the communication network comprise one or more of programmable logic controllers or input/output modules.

At step 815, as detailed above, the process the process models a distribution of packet inter-arrival times between the particular devices based on observing. For example, the process can include modeling the distribution using a mixture of Gaussians.

At step 820, as detailed above, the process detects a problematic change in the packet inter-arrival times between the particular devices based on continued observing. In various embodiments, the problematic change can be a change in periodicity of the packet inter-arrival times above a certain threshold. Embodiments are not so limited, however, and in some embodiments, the process can detect the problematic change by observing intermittent disconnections between the particular devices. Further, as detailed above, the problematic change can be based on a determined threshold.

Embodiments are not so limited, however, and in some embodiments, the problematic change can be an unlikely jitter of the packet inter-arrival times accordingly to a probability threshold. In various embodiments, the process detects the problematic change to filter out isolated jitter events, as discussed above.

Further, in various embodiments, the process can perform root cause analysis on the problematic change. For example, the process can include performing the root cause analysis by correlating the problematic change with CPU load. Embodiments are not so limited, however, and in some embodiments, performing the root cause analysis by correlating the problematic change with interface utilization and/or by correlating the problematic change with network reconfiguration or device reprogramming.

At step 825, as detailed above, the process mitigates the problematic change in the packet inter-arrival times between the particular devices. For example, as discussed above, the process can perform one or more operations to adjust packet inter-arrival times such they are periodic, alter a polling period associated with the packets to cause the packet inter-arrival times to be periodic, and/or provide information to resolve faulty network connector issues, among other methodologies of mitigating the problematic change.

Procedure 800 then ends at step 830.

It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for detection of anomalies in a network, it is to be understood that various other adaptations and modifications may be made within the spirit and scope of the embodiments herein. For example, while certain embodiments are described herein with respect to using certain models for purposes of anomaly detection, the models are not limited as such and may be used for other functions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having computer-executable program instructions stored thereon that execute on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
observing, by a process, a communication network with automated systems for packet inter-arrival times between particular devices having stable or periodic communications within the communication network;
modeling, by the process, a distribution of packet inter-arrival times between the particular devices based on observing;
detecting, by the process, a problematic change in the packet inter-arrival times between the particular devices based on continued observing; and
mitigating, by the process, the problematic change in the packet inter-arrival times between the particular devices.

2. The method as in claim 1, wherein the problematic change is a change in periodicity of the packet inter-arrival times above a certain threshold.

3. The method as in claim 1, wherein the problematic change is an unlikely jitter of the packet inter-arrival times accordingly to a probability threshold.

4. The method as in claim 1, wherein detecting the problematic change comprises: filtering out isolated jitter events.

5. The method as in claim 1, wherein the problematic change is an observation of intermittent disconnections between the particular devices.

6. The method as in claim 1, wherein the problematic change is based on a determined threshold.

7. The method as in claim 1, wherein modeling the distribution uses a mixture of Gaussians.

8. The method as in claim 1 wherein the communication network comprises an industrial network.

9. The method as in claim 1, wherein the particular devices of the communication network comprise low-level autonomous devices.

10. The method as in claim 1, wherein the particular devices of the communication network comprise one or more of programmable logic controllers or input/output modules.

11. The method as in claim 1, further comprising: performing root cause analysis on the problematic change.

12. The method as in claim 11, wherein performing root cause analysis comprises: correlating the problematic change with CPU load.

13. The method as in claim 11, wherein performing root cause analysis comprises: correlating the problematic change with interface utilization.

14. The method as in claim 11, wherein performing root cause analysis comprises: correlating the problematic change with network reconfiguration or device reprogramming.

15. The method as in claim 11, wherein performing root cause analysis comprises: correlating the problematic change with one or more physical connectivity issues.

16. A tangible, non-transitory, computer-readable medium having computer-executable instructions stored thereon that, when executed by a processor on a computer, cause the computer to perform a method comprising:
observing a communication network with automated systems for packet inter-arrival times between particular devices having stable or periodic communications within the communication network;
modeling a distribution of packet inter-arrival times between the particular devices based on observing;
detecting a problematic change in the packet inter-arrival times between the particular devices based on continued observing; and
mitigating the problematic change in the packet inter-arrival times between the particular devices.

17. The tangible, non-transitory, computer-readable medium as in claim 16, wherein the problematic change is a change in periodicity of the packet inter-arrival times above a certain threshold.

18. The tangible, non-transitory, computer-readable medium as in claim 16, wherein the problematic change is an unlikely jitter of the packet inter-arrival times accordingly to a probability threshold.

19. The tangible, non-transitory, computer-readable medium as in claim 16, wherein the problematic change is an observation of intermittent disconnections between the particular devices.

20. An apparatus, comprising:
one or more network interfaces to communicate with a network;
a processor coupled to the one or more network interfaces and configured to execute one or more processes; and
a memory configured to store a process that is executable by the processor, the process, when executed, configured to:
observe a communication network with automated systems for packet inter-arrival times between particular devices having stable or periodic communications within the communication network;
model a distribution of packet inter-arrival times between the particular devices based on observing;
detect a problematic change in the packet inter-arrival times between the particular devices based on continued observing; and
mitigate the problematic change in the packet inter-arrival times between the particular devices.
